(19) United States
(12) Patent Application Publication
(10) Pub. No.: US 2004/0028024 A1
(43) Pub. Date: Feb. 12, 2004

(54) Method of transmitting voice data

(76) Inventors: Cheng-Shing Lai, Taipei Hsien (TW); Yong-Chian Gu, Nanjing (CN); Hung Ding, Nanjing (CN)

Correspondence Address: NAIPO (NORTH AMERICA INTERNATIONAL PATENT OFFICE), P.O. BOX 506, MERRIFIELD, VA, 22116, US

(21) Appl. No.: 10/064,672

(22) Filed: Aug. 6, 2002

(51) Int. Cl. H04L 12/66

(52) U.S. Cl. 370/352; 370/493

(57) ABSTRACT

A method for transmitting audio data between a computer and a GPRS card. The computer is connected to the GPRS card through corresponding connectors. The method includes after the computer receives an audio signal, transforming the audio signal into a digital signal, and packeting the digital signal into a plurality of audio units, then transmitting the plurality of audio units to the GPRS card through the connectors. Finally, the plurality of audio units are transformed to become the original digital signal, and the digital signal is transformed to become the original audio signal.

### BACKGROUND OF INVENTION

1. Field of the Invention

The present invention relates to a voice data transmission method, and more particularly, to a method of transmitting voice information between a computer system and a General Packet Radio Services (GPRS) card.

2. Description of the Prior Art

People often use international dialing to get in touch with friends and family who are out of the country, but a price rate of international phone calls is very expensive, becoming a burden. When a caller is an international business, frequently contacting overseas clients, these charges can become a substantial financial expenditure. With a daily growth in expansion of the Internet, designers have already integrated the Internet with telephone communication to create Internet telephone. Internet telephone users can use a computer microphone and speakers to record and play voice information. Through a sound card in the computer, the recorded information can be converted to digital data and sent to another user. Similarly, the other user can send information back to the original user, who then plays the sound from their computer. In this way, people can use the Internet to accomplish telephone communication. As the cost of the Internet telephone service is very low, users can talk for long periods of time, without worrying about an expensive phone bill. Additionally, because the voice information is processed by the sound card of the computer, the sound quality is very pure.

However, the Internet telephone of the present is mostly limited to sending voice over a wired Internet, and does not have an effective wireless service. This makes it so the user does not have “anytime, anywhere” service when employing the Internet telephone.

### SUMMARY OF INVENTION

Therefore, it is an objective of the claimed invention to provide a method of achieving wireless Internet telephone communication. Particularly, a method of allowing voice signals to be passed between a computer and a GPRS card achieves wireless Internet phone capabilities, and solves the problems faced by the prior art.

The claimed invention method waits for the computer system to receive voice sounds, converts the voice sounds to a voice packet, sends the voice packet over the USB to the GPRS card, and uses the GPRS card to convert the voice packet to a voice signal. The voice signal is then transmitted away wirelessly.

It is an advantage of the claimed invention method that it allows users to perform telephone communication over a wireless network.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a block diagram of a computer system according to the present invention.

FIG. 2 is a block diagram of a GPRS card connected to the computer system of FIG. 1.

FIG. 3 is an execution flow chart of the computer system of FIG. 1.

FIG. 4 is an execution flow chart of the GPRS of FIG. 2.

### DETAILED DESCRIPTION

General Packet Radio Services (GPRS) is a high-speed, broadband, wireless mobile network that was developed by the European Telecommunications Standards Institute, which supports transmission of one 100 KB data packet per second, and is characterized by quick access and high-speed transmissions. Because GPRS has these high-speed, wireless transmission capabilities, the present invention uses a GPRS card in connection with a computer system to send voice information over a wireless network, and perform wireless Internet phone service.

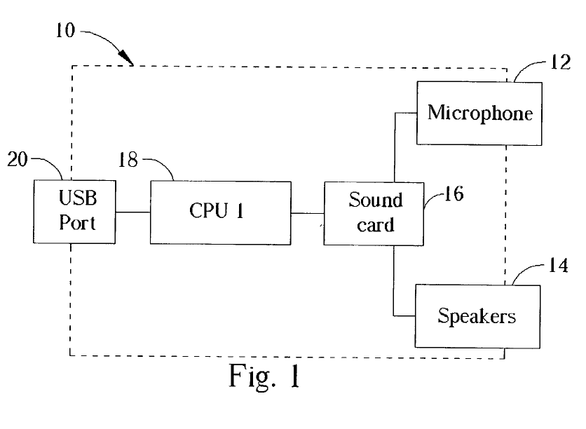

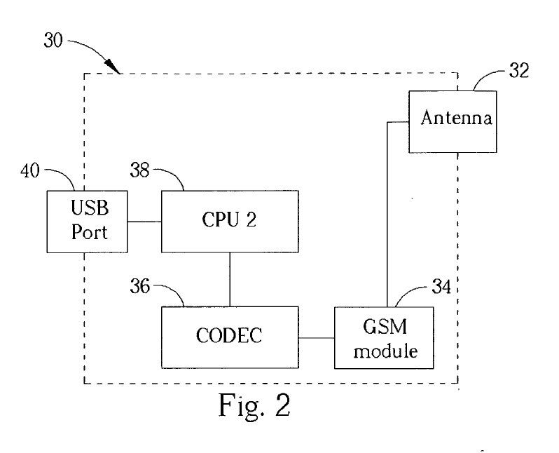

Please refer to FIG. 1 and FIG. 2. FIG. 1 is a block diagram of a computer system 10 of the present invention method. FIG. 2 is a block diagram of a GPRS card 30 of the present invention method. The computer system 10 comprises a microphone 12, a speaker 14, a sound card 16, a first CPU 18, and a USB port 20. The microphone 12 is used to receive voice signals from a user, and the speaker 14 is used to play voice signals. The sound card 16 is connected between the first CPU 18 and the microphone 12 (or the speaker 14). The first CPU 18 is connected between the sound card 12 and the USB port 20. Additionally, the GPRS card 30 comprises an antenna 32, a Global System for Mobile Communications (GSM) module 34, a compression/decompression module (CODEC) 36, a second CPU 38 and a USB port 40. The antenna 32 is used to receive and transmit wireless signals. The GSM module 34 is used to process wireless signals. The CODEC 36 is connected between the GSM module 34 and the second CPU 38. The second CPU 38 is connected between the CODEC 36 and the USB port 40.

To use the wireless Internet phone, the user must first make sure that the GPRS card 30 and the computer system 10 are connected by their respective USB ports 20, 40. Then, the user can open GPRS software in the computer system 10. This allows the user to use the computer system 10 to call out or receive phone calls. At this time, if the user wishes to talk with a distant friend, the user, after connection, can use the microphone 12 of the computer system 10 to input their own voice signal, and the signal is sent to the sound card 16 of the computer system 10. After the sound card 16 receives the signal, the sound card 16 converts the signal to a digital voice signal with pulse-code modulation (PCM). This digital signal is sent ahead to the first CPU 18 of the computer system 10, which uses a special AT command format to package the digital voice signal into a complex voice packet, which is sent to the second CPU 38 of the GPRS card 30 through the USB ports 20,40. The second CPU 38 changes the received packet back into a digital signal, and sends the signal to the CODEC 36, which then turns the digital signal back into a voice signal. The voice signal is then sent to the GSM module 34, which processes the signal, and wirelessly sends it from the antenna 32. In this way, the distant friend can use wireless technology to receive the voice signal of the user.

Similarly, if the distant friend uses wireless technology to send a voice signal, the user can use the antenna 32 of the GPRS card 30 to receive the voice signal. The signal, after being processed by the GSM module 34, is sent to the CODEC 36, which digitizes the signal, and sends it to the second CPU 38. The second CPU 38 packets the digital signal into a complex packet, which is sent through the USB ports 20,40 to the first CPU 18 of the computer system 10. The first CPU 18 converts the packet to a PCM digital signal and sends it to the sound card 16. The sound card 16 converts the PCM signal to a voice signal and plays the voice signal over the speakers 14 that are installed in the computer system 10. In this way, the user can receive voice signals from the distant friend.

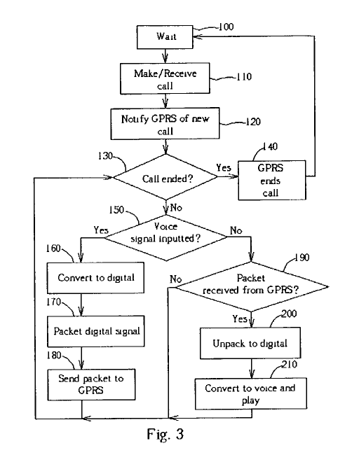

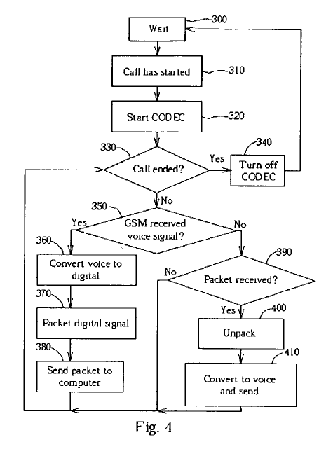

Please refer to FIG. 3 and FIG. 4. FIG. 3 is an execution flow chart of the computer 10 of the present invention method. FIG. 4 is an execution flow chart of the GPRS card 30 of the present invention method. The present invention method can be split into two parts: the execution flow of the computer system 10, and the execution flow of the GPRS card 30. The steps are as follows:

Execution of the computer system 10:

Step 100:

User connects the computer system 10 and the GPRS card 30 through the USB ports 20,40, and opens software of the GPRS card 30 that is in the computer 10. The software enters a waiting state. Go to step 110.Step 110: User dials or receives a call. Go to step 120;

Step 120:

The computer system 10 sends a signal to the GPRS card 30 to tell the GPRS card 30 that the user has already started telephone communication. Go to step 130;

Step 130:

Determine whether or not the user has finished telephone communication. If finished, go to step 140, else go to step 150;

Step 140:

The computer system 10 sends a signal to the GPRS card 30 telling the GPRS card 30 that the user has finished telephone communication. Return to step 100;

Step 150:

Determine whether or not the user is using the microphone 12 of the computer system 10 to input voice signals. If not, go to step 160, else go to step 190;

Step 160:

Send the voice signal inputted by the user to the sound card 16, use the sound card 16 to convert the voice signal to a PCM signal, and send the PCM signal to the first CPU 18. Go to step 170;

Step 170:

After the first CPU 18 receives the PCM signal, use a special AT command format to packet the digital signal into a complex packet. Go to step 180;

Step 180:

Send the packet through the USB ports 20, 40 to the GPRS card 30 to perform further processing. Return to step 130;

Step 190:

Determine whether or not a voice packet has been received from the GPRS card 30. If so, go to step 200, else return to step 130;

Step 200:

Send the voice packet received from the GPRS card 30 to the first CPU 18. Use the first CPU 18 to convert the received voice packet to a PCM signal, and send the PCM signal to the sound card 16. Go to step 210;

Step 210: After the sound card 16 receives the PCM signal, use the sound card 16 to convert the PCM signal to a voice signal, and play the voice signal over the speakers 14. Return to step 130.

Execution of the GPRS card 30:

Step 300:

GPRS card 30 enters a wireless Internet telephone waiting state. Go to step 310;

Step 310:

Use a signal received from the computer system 10 to tell the user that telephone communication has begun. Go to step 320;

step 320:Start the CODEC 36. Go to step 330;

Step 330:

Determine whether or not a signal has been received from the computer system 10 indicating that the user has ended telephone communication. If so, go to step 340. Else, go to step 350;

Step 340:

GPRS card 30 received a terminate telephone communications signal from the computer system 10. Turn off the CODEC 36. Return to step 300;

Step 350:

Determine whether or not the GSM module 34 is receiving voice signals over the antenna 32. If so, go to step 360. Else, go to step 390;

Step 360:

Send the voice signal from the GSM module 34 to the CODEC 36. Use the CODEC 36 to convert the voice signal to a digital signal, and send the digital signal from the CODEC 36 to the second CPU 38. Go to step 370;

Step 370:

After the second CPU 38 receives the signal, use the second CPU 38 to convert the digital signal to a complex voice packet. Go to step 380;

Step 380:

Send the complex voice packet to the computer system 10 through the USB ports 20, 40. Return to step 330;

Step 390:

Determine whether or not the second CPU 38 has received a voice packet from the computer system 10. If so, go to step 400. Else, return to step 330;

Step 400:

Use the second CPU 38 to convert the voice packet received from the computer system 10 to a digital signal, and send the digital signal from the second CPU 38 to the CODEC 36. Go to step 410;

Step 410: Use the CODEC 36 to convert the digital signal to a voice signal, and send the voice signal to the GSM module 34. Use the GSM module 34 to send the voice signal out over the antenna 32. Return to step 330.

Compared to the prior art, the present invention method uses the computer system 10 connected with the GPRS card 30 to achieve wireless Internet telephone communication. Thus, the user not only enjoys the low cost of Internet telephone, but can also benefit from the convenience of wireless network transmission. Additionally, GPRS provides high-speed, broadband wireless access, so the user can freely communicate with distant friends, not having to worry about Internet traffic or disconnections.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of transmitting voice data between a computer system and a General Packet Radio Services (GPRS) card, the computer system and the GPRS card connected over a Universal Serial Bus (USB), the method comprising:
after the computer system receives voice sounds, converting the voice sounds to a voice packet;
sending the voice packet over the USB to the GPRS card; and
using the GPRS card to convert the voice packet to a voice signal, the voice signal transmitted wirelessly away.

2. The method of claim 1 further comprising:
after the GPRS receives a wirelessly transmitted voice signal, converting the wirelessly transmitted voice signal to a voice packet;
sending the voice packet over the USB to the computer system; and
using the computer system to convert the voice packet to voice sounds, and playing the voice sounds.

3. The method of claim 1 wherein the computer system further comprises a microphone used to record voice sounds of a user.

4. The method of claim 1 wherein the computer system further comprises a speaker system that plays the voice sounds.

5. The method of claim 1 wherein the computer system further comprises a sound card, the method further comprising using the sound card to convert voice sounds inputted by a user to pulse-code modulation (PCM) voice data, or to convert PCM voice data to voice sounds.

6. The method of claim 5 wherein the computer system further comprises a central processing unit (CPU), the method further comprising using the CPU to convert a PCM signal from the sound card to a voice packet or using the CPU to convert a voice packet from the USB to a PCM voice signal.

7. The method of claim 1 wherein the GPRS card further comprises an antenna for transmitting and receiving wireless voice signals.

8. The method of claim 7 wherein the GPRS card further comprises a Global System for Mobile Communications (GSM) module for transmitting and receiving voice signals through the antenna.

9. The method of claim 1 wherein the GPRS card further comprises a compressor/decompressor module (CODEC), the method further comprising using the CODEC to convert voice signals from the GSM module to voice data, or to convert voice data to voice signals.

10. The method of claim 9 wherein the GPRS card further comprises a central processing unit (CPU), the method further comprising using the CPU to convert voice data received from the CODEC to voice packets, or to convert voice packets received over the USB to voice data.
